(19) United States
(12) Patent Application Publication
(10) Pub. No.: US 2026/0186931 A1
(43) Pub. Date: Jul. 2, 2026

(54) SYSTEM AND METHOD FOR DATA RECOVERY

(71) Applicant: Aivres Systems Inc., San Jose, CA (US)

(72) Inventor: Yuan Cheng CHANG, New Taipei City (TW)

(21) Appl. No.: 19/005,121

(22) Filed: Dec. 30, 2024

(51) Int. Cl. G06F 11/20; G06F 11/32

(52) U.S. Cl. CPC G06F 11/2082; G06F 11/327

(57) ABSTRACT

Systems and methods for data recovery are provided. In at least one embodiment, a method comprises reading first data for a system from a first memory and storing the first data in a second memory of a control device, the first data corresponding to information relating to one or more components in the system; detecting, by the control device, one or more commands to update the first data; after updating the first data in the second memory, verifying the updated first data in the second memory; and based on identifying one or more errors in the updated first data, restoring the first data in the second memory based on the first data in the first memory.

### BACKGROUND

Computer systems, such as servers, typically include memory such as an electrically-erasable programmable read-only memory (EEPROM). Data, such as field replaceable unit (FRU) information, may be stored in a designated valid address segment of the memory. A controller such as a baseboard management controller (BMC) communicates with the memory, e.g., EEPROM, via a communication path such as an inter-integrated circuit (I2C) bus. However, errors in writing data or damage to stored information can lead to various issues. For example, interfaces, such as an IPMITOOL utility, might fail to write data, or an improperly imported FRU bin file could corrupt or erase existing information. Such issues can in certain instances cause significant disruptions and impact critical functions. For example, the BMC or basic input/output system (BIOS) may rely on specific FRU fields to enable certain features. In these cases, corrupted FRU data can result in malfunctions of BMC or BIOS functionalities or prevent remote operators from accessing vital hardware system information.

Additionally, when data such as FRU data is corrupted, rebuilding the field data can be time-consuming. Some information, such as the board part number or serial number, may be difficult to recover, often necessitating physical inspection of a circuit board label or other specification. This process may require opening the system and/or shutting it down, which can lead to temporary system downtime. For large implementations, such as data centers, these interruptions may result in operational losses, interruptions in service and the like.

### SUMMARY

In an exemplary embodiment, a method for data recovery is provided. The method includes reading first data for a system from a first memory and storing the first data in a second memory of a control device, the first data corresponding to information relating to one or more components in the system; detecting, by the control device, one or more commands to update the first data; after updating the first data in the second memory, verifying the updated first data in the second memory; and based on identifying one or more errors in the updated first data, restoring the first data in the second memory based on the first data in the first memory.

In a further exemplary embodiment, a system is provided. The system includes one or more components; a first memory storing first data corresponding to information relating to the one or more components; a control device comprising a second memory. The control device is configured to read first data for the one or more components in the system from the first memory and store the first data in the second memory of the control device; detect one or more commands to update the first data; after updating the first data in the second memory, verify the updated first data in the second memory; and based on identifying one or more errors in the updated first data, restore the first data in the second memory based on the first data in the first memory.

In yet a further exemplary embodiment, a non-transitory computer-readable medium is provided. The non-transitory computer-readable medium has stored thereon a set of instructions. The set of instructions, which if performed by one or more processors, cause the one or more processors to read first data for a system from a first memory and storing the first data in a second memory of a control device, the first data corresponding to information relating to one or more components in the system; detect, by the control device, one or more commands to update the first data; after updating the first data in the second memory, verify the updated first data in the second memory; and based on identifying one or more errors in the updated first data, restore the first data in the second memory based on the first data in the first memory.

### BRIEF DESCRIPTION OF THE DRAWINGS

Systems and methods for data recovery are described in detail below with reference to the attached drawing figures, wherein:

FIG. 1A illustrates a block diagram of a system according to one or more embodiments of the present disclosure.

FIG. 1B is a block diagram illustrating a management scheme of a system according to one or more embodiments of the present disclosure.

FIG. 1C is a table illustrating a file format according to one or more embodiments of the present disclosure.

FIG. 2 illustrates a method for monitoring data according to one or more embodiments of the present disclosure.

FIG. 3 illustrates a method for monitoring data according to one or more embodiments of the present disclosure.

### DETAILED DESCRIPTION

The following detailed description is merely exemplary in nature and is not intended to limit the disclosure or the application and uses of disclosed embodiments and methods. Furthermore, there is no intention to be bound by any expressed or implied theory presented in the preceding background, summary, brief description of the drawings or the description that follows.

Systems and methods are disclosed herein that relate to the automatic recovery of field data, such as replaceable unit (FRU) data, and in particular, to the utilization of a controller, such as a baseboard management controller (BMC), and its associated memory to monitor and address issues arising from changes to the data. The systems and methods described herein can enhance automation and responsiveness of system management, such as FRU management.

By way of example, the systems and methods utilize the BMC to execute a monitoring program designed to quickly and accurately identify events for verifying the FRU data and to automatically recover from FRU failures. This approach reduces the need for manual intervention while enhancing system stability and maintenance efficiency. By continuously monitoring the status of FRUs in real time, the systems and methods automatically perform recovery operations or notify administrators to take further action when a failure is detected, ensuring efficient system operation even in unattended scenarios.

Among other things, the systems and methods provided herein can be used to automatically restore previous information after data corruption. For example, when a user accidentally writes data that is not in a predefined format to a memory designated to store system data, data corruption can occur. The methods and systems disclosed herein can automatically and quickly restore the previous system data, ensuring that the data is promptly recovered and not permanently damaged due to either intentional or unintentional corruption.

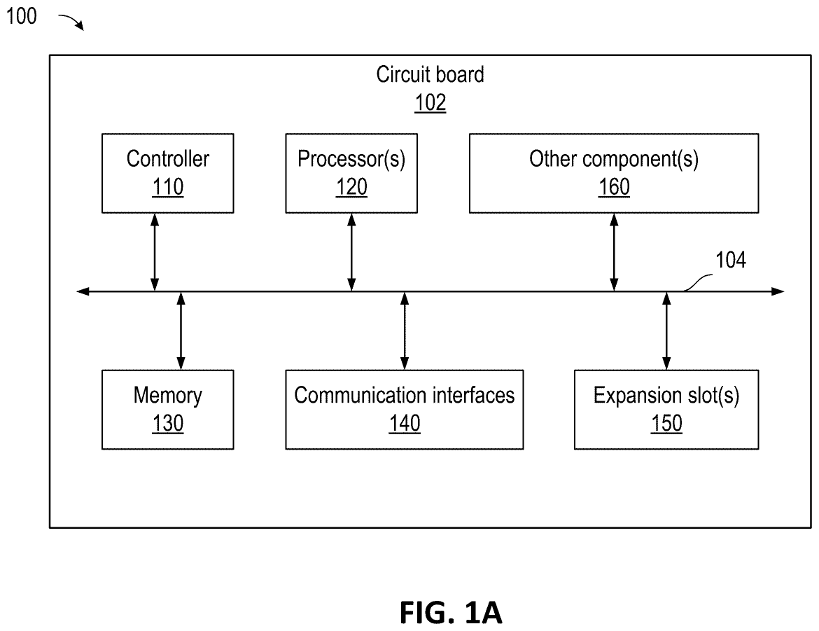

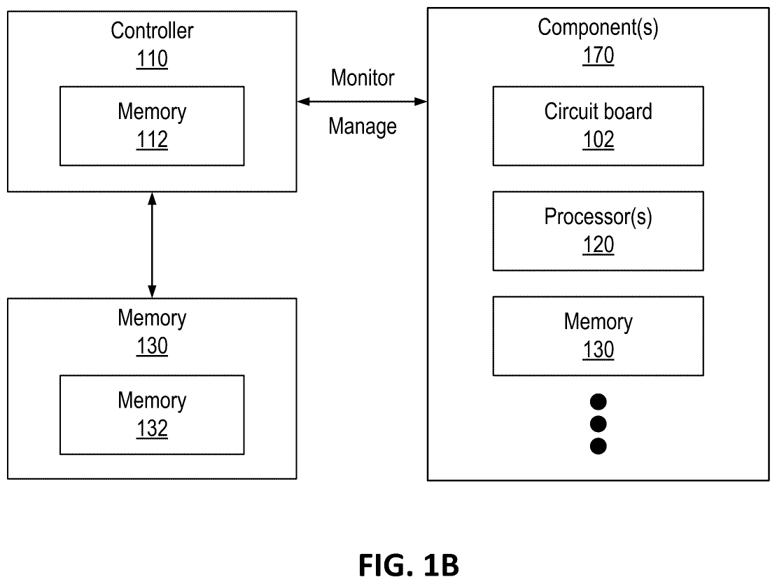

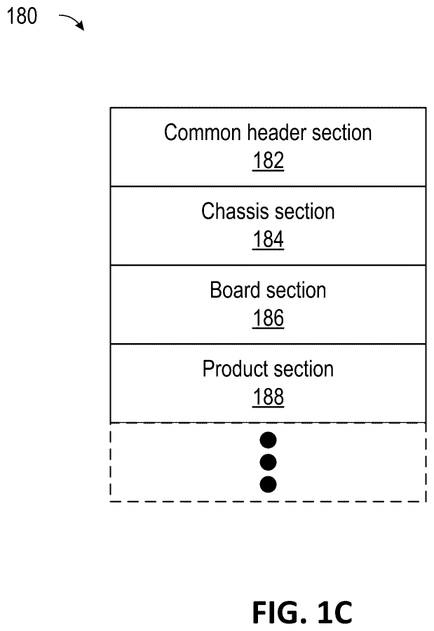

FIG. 1A illustrates a block diagram of a system 100, e.g., server, suitable for use in implementing embodiments of the present disclosure. It should be noted that the arrangements described herein, including this example, are provided for illustrative purposes only. Alternative configurations and components may be used in place of or in addition to those shown, and some components may be omitted entirely. Moreover, many of the elements described are functional in nature and can be implemented as standalone or distributed units, either independently or in combination with other components, and located in various configurations. The functions discussed may be executed through hardware, firmware, and/or software, with processes typically performed by a processor running instructions stored in memory. Additionally, those skilled in the art will recognize that any system capable of performing the operations of the server system 100 falls within the scope and intent of the disclosed embodiments. The server system 100 can be housed in a rack-mounted chassis designed for optimal airflow and cooling, ensuring efficient heat dissipation during operation. Yet further, a person skilled in the art will recognize that the systems and methods described herein can be used with computer systems other than server systems.

The system 100 typically includes one or more circuit boards, e.g., a motherboard 102, that may carry various components, including hardware, firmware, and/or software, which may be integrated with, attached to, connected to, or in communication with the motherboard. As shown in FIG. 1A, the motherboard 102 carries at least one controller 110, such as a baseboard controller (BMC), one or more processors 120, memory 130, communication interfaces 140, one or more expansion slots 150, and one or more other components 160. Such components and the circuit board 102 can communicate with one another through a bus 104 (e.g., integrated into the circuit board 102).

Processor(s) 120 may be configured to perform the operations in accordance with the instructions stored in memory 130. In certain embodiments, the memory 130 may be integral to the processor(s) 120. In other embodiments, the memory may in whole or in part be separate from the processor(s) 120. Processor(s) 120 may include any appropriate type of general-purpose or special-purpose microprocessor (e.g., a central processing unit (CPU) or graphics processing unit (GPU), respectively), digital signal processor, microcontroller, or the like. Memory 130 may be configured to store computer-readable instructions that, when executed by processor(s) 130, can cause processor(s) 120 to perform various operations disclosed herein and/or store data relating thereto.

Memory 130 may be any non-transitory type of mass storage, such as volatile or non-volatile, magnetic, semiconductor-based, tape-based, optical, removable, non-removable, or other type of storage device or tangible computer-readable medium including, but not limited to, a read-only memory (“ROM”), EEPROM, a flash memory, a dynamic random-access memory (“RAM”), and/or a static RAM. In certain embodiments, memory 130 may include multiple storage devices of various types.

Communication interfaces 140 may be configured to communicate information between system 100 and other devices or systems. For example, communication interfaces 140 may include an integrated services digital network (“ISDN”) card, a cable modem, a satellite modem, or a modem to provide a data communication connection. As another example, communication interfaces 140 may include a local area network (“LAN”) card to provide a data communication connection to a compatible LAN. As a further example, communication interfaces 140 may include a high-speed network adapter such as a fiber optic network adaptor, 10 G Ethernet adaptor, or the like. Wireless links can also be implemented by communication interfaces 140. In such an implementation, communication interfaces 140 can send and receive electrical, electromagnetic, or optical signals that carry digital data streams representing various types of information via a network. The network can typically include a cellular communication network, a Wireless Local Area Network (“WLAN”), a Wide Area Network (“WAN”), or the like.

Controller 110, e.g., BMC, may include a processing unit, internal memory (e.g., memory 112 as shown in FIG. 1B), and communication interfaces, and is configured to monitor and manage the system's hardware components among other things. Controller 110 handles tasks such as remote system management, including hardware health monitoring, system event logging, and power control. Controller 110 can operate independently of the system's 100 main processor (e.g., processor(s) 120), allowing for out-of-band management. Controller 110 may in certain embodiments facilitate communication with various sensors (e.g., other component(s) 160) on the circuit board 102 to track temperature, fan speed, voltage levels, and other critical parameters. Additionally, the controller 110 may include network interfaces and/or operate in conjunction with communication interfaces 140 to enable remote access for system administrators, providing a way to perform diagnostic tasks, power cycling, and firmware updates.

The expansion slot(s) 150 on the circuit board 102 may be used for connecting additional peripherals, such as GPUs, network cards, and more.

The other components 160 can include integrated components, replaceable components, and other suitable components. For example, these components may include but are not limited to sensors, cooling devices, power supply modules (and/or connectors), clock generators, and more.

FIG. 1B is a block diagram illustrating a management scheme of a system 100 using controller 110, in accordance with one or more embodiments in the present disclosure.

As shown in FIG. 1B, controller 110 is configured to monitor and/or manage one or more components 170 in the system 100. In certain embodiments, some or all of the components 170 in the system 100 can be referred to as field-replace units (FRUs). The components 170 may include one or more components as illustrated in FIG. 1A, such as circuit board 102, processor(s) 120, memory 130, communication interfaces 140, components connected to the circuit board 102 through the extension slots 150, and/or other components 160. Each component 170 is associated with predefined information (e.g., to describe or record the status of the respective component 170), such as part numbers, serial numbers, manufacturing details, and other system-specific metadata. In certain embodiments, the predefined information of component 170 is defined in a data file, such as an FRU bin file. In certain embodiments, in an FRU device, the FRU bin file is stored in memory, which in certain embodiments is a EEPROM chip integrated within the device. The EEPROM serves as non-volatile memory that retains the stored information even when the device is powered off.

The controller 110, e.g., BMC, is coupled to a memory 112, which in certain embodiment may be an internal memory, configured to store system logs, operational data, and other suitable data to manage hardware resources, log events, and provide remote access for system administrators. In at certain embodiments, the memory 112 may temporarily store data for real-time tasks.

In certain embodiments, memory 130 may include a memory 132 (e.g., a EEPROM) configured to store FRU files (e.g., FRU bin files) and/or BIOS (e.g., ROM BIOS, system BIOS, and/or personal computer (PC) BIOS) associated with the entire system 100. In certain embodiments, the memory designated to store the data file, e.g., FRU file, of the circuit board 102 may also be utilized to store the data files, e.g., FRU files, associated with other components in the system 100.

Various protocols/programs can be utilized for the controller 110 to interact with other components. As but one example, IPMITOOL is a software utility that implements the Intelligent Platform Management Interface (IPMI) protocol, allowing system administrators to communicate with a controller, such as a BMC, and perform tasks defined by IPMI. FRU write command is an instruction used to write or update the FRU data (FRU files) stored in memory associated with a specific FRU device. FRU read command is an instruction used to retrieve the FRU data stored in the memory of an FRU device. This FRU read and write commands are part of the IPMI specification and can be executed using tools like IPMITOOL or similar utilities. In certain embodiments, non-standard IPMI commands or customized commands, such as OEM command, may be utilized for specific purposes based on customer requirements or use case scenarios.

Controller 110 retrieves data file from one or more components 170 and store the data file in the memory 130 (e.g., in memory 132) in various scenarios. In certain embodiments, controller 110 may retrieve the data file during system boot-up. For example, when the system 100 is powered on or reset, controller 110 may access the data file stored in the memory of the component(s) 170 to initialize the system 100 and provide information such as part numbers, serial numbers, and configuration details for the hardware components (e.g., the components 170) to name but a few examples. In certain embodiments, controller 110 may retrieve and/or update data files during hardware replacement or upgrades, as well as during controller initialization or update.

As will be detailed hereinafter, controller 110 utilizes a monitoring program to monitor status of the data file and perform automatic recovery. The monitoring program may be written in any suitable programing languages, such as C language, which may be executed and stored within the controller.

FIG. 1C is a table illustrating the format of data file, such as an FRU file 180, in accordance with one or more embodiments in the present disclosure. As shown in FIG. 1C, FRU file 180 includes multiple sections containing data or information. Examples of sections include a common header section 182, a chassis section 184, a board section 186, and a product 188. It should be noted that the arrangements described herein, including this example, are provided for illustrative purposes only. Alternative configurations and components may be used in place of or in addition to those shown, and some components may be omitted entirely.

Each section may include verification information (e.g., an error-checking code) that allows a monitoring program to calculate and/or verify the accuracy of the data (e.g., FRU data) stored in that section. In certain embodiments, the FRU file 180 may include a section that logs events associated with the corresponding FRU device.

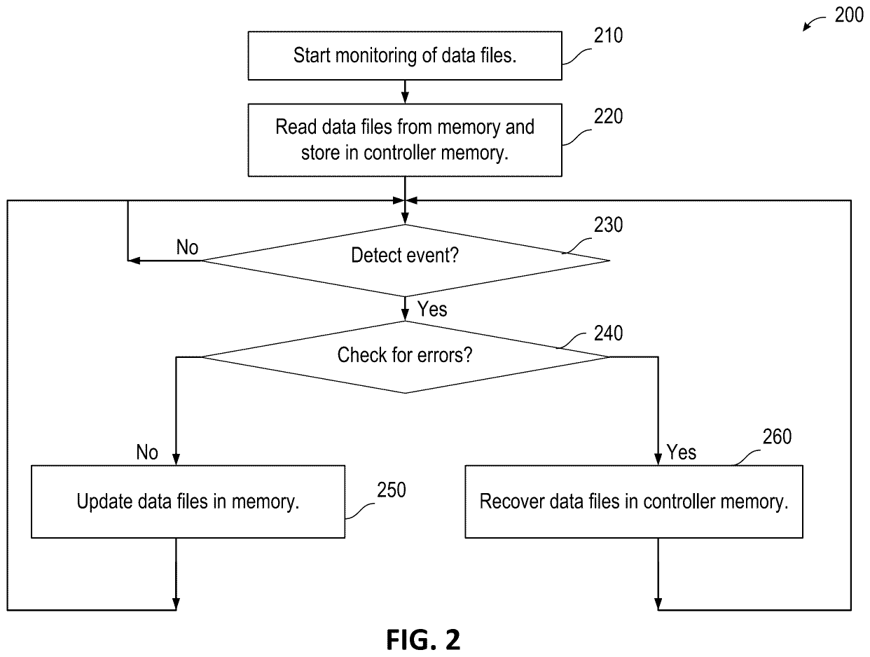

FIG. 2 illustrates a method 200 for monitoring data, in accordance with one or more embodiments of the present disclosure. Method 200 may be performed by controller 110 as illustrated in FIGS. 1A and 1B or other suitable control devices. Method 200 may be performed alone or in combination with other processes in the present disclosure. It will be recognized that method 200 may be performed in any suitable environment and in any suitable order except where otherwise apparent. Alternative steps/stages may be performed instead of or in addition to those shown, and some steps/stages may be omitted entirely. In certain embodiments, the controller 110 can be implemented as a BMC. The data to be monitored may be FRU data files associated with FRU devices. FRU data files can be stored in a designated memory, such as a EEPROM, and retrieved by the controller 110.

At stage 210, controller 110 starts monitoring data files. In at least one embodiment, controller 110 receives instructions to initiate a monitoring program based on user input.

At stage 220, controller 110 reads the data files from memory 132 within the memory 130 and stores the data files in a memory 112 of controller 110.

At stage 230, controller 110 monitors events to trigger error checks. In certain embodiments, controller 110 monitors events for checking the data files in the memory 112 of controller 110. The memory 112 of controller 110 is also referred to as controller memory 112. In certain embodiments, the data files may be FRU files. Controller 110 may continuously monitor for any triggering events while the monitoring program is running. In certain embodiments, an event that involves changes to the data files may trigger the error checking. For example, the event may be associated with instructions to write FRU data to the memory 132 within the memory 130 and/or to the controller memory 112.

At stage 240, after controller 110 detects an event at stage 230, controller 110 checks if there is any error in the data files in the controller memory 112. Controller 110 may perform error checking based on verification information (e.g., an error-checking code) associated with each section in the data files. For example, controller 110 may may calculate a check value for one or more portions (e.g., sections) in the data files and compare the calculated check value with a reference value (e.g., an error-checking code) associated with the corresponding portion. If for each portion (or section) to be verified, the calculated check value matches the reference value, it indicates that the data files in the controller memory 112 are correct.

At stage 250, if controller 110 does not identify any error in the data files in the controller memory 112, controller 110 updates the data files in the memory 132 within the memory 130 based on the updated data files in the controller memory 112.

Alternatively, at stage 260, if controller 110 identifies one or more errors in the data files in the controller memory 112, controller 110 restores the data files in the controller memory 112 based on the data files stored in the memory 132 within the memory 130. For example, controller 110 retrieves previously saved data files from the memory 132 within the memory 130 and uses the retrieved data to overwrite one or more sections of the data files saved in the controller memory 112.

In certain embodiments, after performing stage 240, controller 110 may present the checking results on a user interface, enabling users to review the results and address any issues as needed.

After resolving the trigger event detected at stage 240, controller 110 continues monitoring for the next event until the monitoring program is ended.

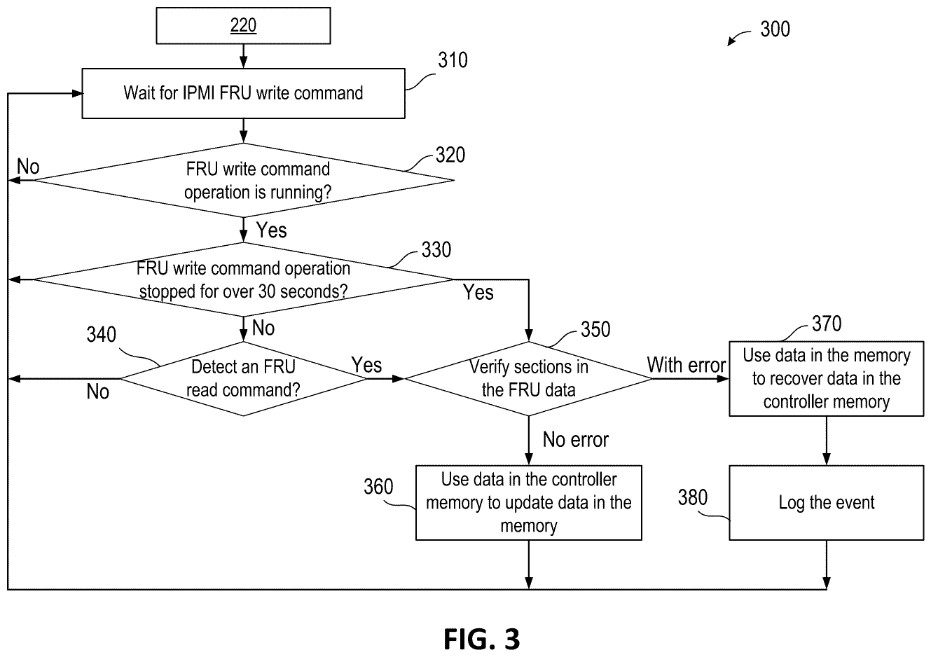

FIG. 3 illustrates a method 300 for monitoring data, in accordance with one or more examples of the present disclosure. Method 300 may be performed by controller 110 as illustrated in FIGS. 1A and 1B or other suitable control devices. Method 300 may be performed alone or in combination with other processes in the present disclosure. It will be recognized that method 300 may be performed in any suitable environment and in any suitable order except where otherwise apparent. Alternative steps/stages may be performed instead of or in addition to those shown, and some steps/stages may be omitted entirely. In certain embodiments, the steps/stages outlined in method 300 may be carried out following stage 220, as shown in FIG. 2. These steps/stages can either serve as alternatives to or provide exemplary implementations of one or more of the subsequent steps/stages (e.g., stages 230-260) in method 200. In certain embodiments, controller 110 may be embodied as a BMC. In this example, certain IPMI commands, such as FRU read and write commands, are used to access and/or modify the FRU data in the controller memory 112 associated with controller 110. In certain embodiments, the FRU data in controller 110 can be displayed in a user interface.

At stage 310, controller 110 waits for an IPMI FRU write command. An IPMI FRU write command (or an FRU write command) can instruct controller 110 to write or modify FRU data in the controller memory 112.

At stage 320, after detecting an FRU write command, controller 110 monitors the operation of the FRU write command. For example, the monitoring of the FRU write command operation may be triggered by the start of the FRU write command action.

At stage 330, controller 110 monitors after the FRU write command operation is completed for a preset time-period. For example, upon completion of the FRU write command operation, controller 110 may initiate a timer. In one example, a threshold time period may be set to 30 seconds. While the timer is running, controller 110 may continue monitoring for any other issued commands (e.g., by performing stage 310). If another FRU write command is detected, controller 110 may stop the timer, perform stage 320, and then start a new timer upon completing stage 320.

Controller 110 may determine to proceed to stage 350 based on various conditions. Under a first condition, if the timer exceeds the preset threshold time-period (e.g., more than 30 seconds have passed) after the FRU write command operation stops, and controller 110 has not received any further FRU write commands, controller 110 proceeds to stage 350.

Alternatively, under a second condition (as shown in stage 340), if controller 110 detects an FRU read command (e.g., initiated by the user) to perform an FRU read operation, controller 110 proceeds to stage 350.

In certain embodiments, since the FRU write command in the IPMI standard can transmit data to controller 110 in several segments, depending on the offset of the address, the number of write operations, or the length of the data. It is difficult to predict how much data the IPMITOOL software will write before it concludes. As a result, controller 110 may face challenges in detecting the exact moment when the FRU write operation finishes, using conventional methods. In this case, controller 110 utilizes a combination of FRU read and wait time checks to accurately trigger the FRU data verification (at stage 350), ensuring that the written FRU data is properly validated or restored.

At stage 350, controller 110 performs verification on various sections in the FRU data stored in the controller memory 112. For example, controller 110 checks the correctness of the FRU data recently written to the controller memory 112. Controller 110 may check some or all sections of the FRU data stored in the controller memory 112. For example, controller 110 may calculate a check value for each FRU section and compare the calculated check value with a reference value (e.g., an error-checking code) associated with each section. If the calculated check values for all sections match the reference values, it indicates that the FRU data in the controller memory 112 is correct.

At stage 360, based on detecting no error at stage 350, controller 110 uses updated data in the controller memory 112 to update the FRU data in the memory 132 within the memory 130. In certain embodiments, controller 110 calculates check values for each FRU section, including the header, chassis, product, and board, and compares the calculated check values with the reference values recorded in each section. If the calculated check values for all sections match the corresponding reference values (e.g., the error-checking codes), it indicates that the data is correct. In this case, controller 110 writes the FRU data stored in the controller memory 112 into the FRU data section of the memory 132, for example, via the I2C bus.

At stage 370, based on detecting one or more errors at stage 350, controller 110 uses previously stored FRU data in the memory 132 within the memory 130 to restore the data in the controller memory 112.

In certain embodiments, at stage 350, controller 110 calculates and verifies check values of various FRU sections in the controller memory 112, such as header, chassis, product, and board sections as depicted in FIG. 1C. If the calculated check value for any section fails to match a reference value, it indicates that the data in that section is invalid or contains errors. In such cases, controller 110 reads the entire FRU data from the FRU storage area in memory 132 within the memory 130 and write it back into the controller memory 112. This operation may be performed whenever an issue is detected in any section of the FRU data.

At stage 380, if the FRU data in the controller memory 112 is restored, controller 110 may record a log entry. This log allows users to know that the FRU data written by the recent FRU write command had an issue.

In certain embodiments, controller 110 continues running method 300 until the monitoring program is ended.

It is noted that the techniques described herein may be embodied in executable instructions stored in a non-transitory computer readable medium for use by or in connection with a processor-based instruction execution machine, system, apparatus, or device. It will be appreciated by those skilled in the art that, for some embodiments, various types of computer-readable media can be included for storing data. As used herein, a “computer-readable medium” includes one or more of any suitable media for storing the executable instructions of a computer program such that the instruction execution machine, system, apparatus, or device may read (or fetch) the instructions from the computer-readable medium and execute the instructions for carrying out the described embodiments. Suitable storage formats include one or more of an electronic, magnetic, optical, and electromagnetic formats. A non-exhaustive list of conventional exemplary computer-readable medium includes: a portable computer diskette; a random-access memory (RAM); a read-only memory (ROM); an erasable programmable read only memory (EPROM); a flash memory device; and optical storage devices, including a portable compact disc (CD), a portable digital video disc (DVD), and the like.

It should be understood that the arrangement of components illustrated in the attached Figures are for illustrative purposes and that other arrangements are possible. For example, one or more of the elements described herein may be realized, in whole or in part, as an electronic hardware component. The elements may be implemented in software, hardware, or a combination of software and hardware. Moreover, some or all of these other elements may be combined, some may be omitted altogether, and additional components may be added while still achieving the functionality described herein. Thus, the subject matter described herein may be embodied in many different variations, and all such variations are contemplated to be within the scope of the claims.

To facilitate an understanding of the subject matter described herein, many aspects are described in terms of sequences of actions. It will be recognized by those skilled in the art that the various actions may be performed by specialized circuits or circuitry, by program instructions being executed by one or more processors, or by a combination of both. The description herein of any sequence of actions is not intended to imply that the specific order described for performing that sequence must be followed. All methods described herein may be performed in any suitable order unless otherwise indicated herein or otherwise clearly contradicted by context.

The use of the terms “a” and “an” and “the” and similar references in the context of describing the subject matter (particularly in the context of the following claims) are to be construed to cover both the singular and the plural, unless otherwise indicated herein or clearly contradicted by context. The use of the term “at least one” followed by a list of one or more items (for example, “at least one of A and B”) is to be construed to mean one item selected from the listed items (A or B) or any combination of two or more of the listed items (A and B), unless otherwise indicated herein or clearly contradicted by context. Furthermore, the foregoing description is for the purpose of illustration only, and not for the purpose of limitation, as the scope of protection sought is defined by the claims as set forth hereinafter together with any equivalents thereof. The use of any and all examples, or exemplary language (e.g., “such as”) provided herein, is intended merely to better illustrate the subject matter and does not pose a limitation on the scope of the subject matter unless otherwise claimed. The use of the term “based on” and other like phrases indicating a condition for bringing about a result, both in the claims and in the written description, is not intended to foreclose any other conditions that bring about that result. No language in the specification should be construed as indicating any non-claimed element as essential to the practice of the invention as claimed.

1. A method for data recovery, comprising:
reading first data for a system from a first memory and storing the first data in a second memory of a control device, the first data describing or recording status of one or more components in the system;
detecting, by the control device, one or more commands to update the first data;
after updating the first data in the second memory, verifying the updated first data in the second memory; and
based on identifying one or more errors in the updated first data, restoring the first data in the second memory by overwriting one or more sections of the updated first data using the first data in the first memory, the one or more sections corresponding to the one or more errors identified in the updated first data.

2. The method of claim 1, further comprising:
based on identifying no errors in the updated first data, writing the updated first data into
the first memory.

3. The method of claim 1, wherein the control device is a baseboard management controller (BMC), the second memory is a memory of the BMC, and the first data is field replaceable unit (FRU) data.

4. The method of claim 1, further comprising:
determining whether the update of the first data in the second memory is complete; and
based on detecting that the update of the first data in the second memory is complete, verifying the updated first data in the second memory.

5. The method of claim 4, wherein determining whether the update of the first data in the second memory is complete comprises:
determining whether a wait period following a most recent write operation that has been completed exceeds a preset time-period; or
determining whether a read operation is to be executed after the most recent write operation.

6. The method of claim 5, further comprising:
based on detecting another write operation within the preset time-period, executing the another write operation; and
restarting the waiting period upon completion of the another write operation.

7. The method of claim 1, further comprising:
logging an entry recording the instance of first data restoration.

8. The method of claim 1, further comprising:
notifying, through a user interface, the one or more errors identified in the updated first data.

9. A system, comprising:
one or more components;
a first memory storing first data describing or recording status of the one or more components;
a control device comprising a second memory,
wherein the control device is configured to:
read first data for the one or more components in the system from the first memory and store the first data in the second memory of the control device;
detect one or more commands to update the first data;
after updating the first data in the second memory, verify the updated first data in the second memory; and
based on identifying one or more errors in the updated first data, restore the first data in the second memory by overwriting one or more sections of the updated first data using the first data in the first memory, the one or more sections corresponding to the one or more errors identified in the updated first data.

10. The system of claim 9, wherein the control device is configured to:
based on identifying no errors in the updated first data, write the updated first data into the first memory.

11. The system of claim 9, wherein the control device is a baseboard management controller (BMC), the second memory is a memory of the BMC, and the first data is field replaceable unit (FRU) data.

12. The system of claim 9, wherein the control device is configured to:
determine whether the update of the first data in the second memory is complete; and
based on detecting that the update of the first data in the second memory is complete, verify the updated first data in the second memory.

13. The system of claim 12, wherein determining whether the update of the first data in the second memory is complete comprises:
determine whether a wait period following a most recent write operation that has been completed exceeds a preset time-period; or
determine whether a read operation is to be executed after the most recent write operation.

14. The system of claim 13, wherein the control device is configured to:
based on detecting another write operation within the preset time-period, execute the another write operation; and
restart the waiting period upon completion of the another write operation.

15. The system of claim 9, wherein the control device is configured to:
log an entry recording the instance of first data restoration.

16. The system of claim 9, wherein the control device is configured to:
notify, through a user interface, the one or more errors identified in the updated first data.

17. A non-transitory computer-readable medium having stored thereon a set of instructions, which if performed by one or more processors, cause the one or more processors to:
read first data for a system from a first memory and storing the first data in a second memory of a control device, the first data describing or recording status of one or more components in the system; and
detect, by the control device, one or more commands to update the first data;
after updating the first data in the second memory, verify the updated first data in the second memory; and
based on identifying one or more errors in the updated first data, restore the first data in the second memory by overwriting one or more sections of the updated first data using the first data in the first memory, the one or more sections corresponding to the one or more errors identified in the updated first data.

18. The non-transitory computer-readable medium of claim 17, wherein the set of instructions cause the one or more processors to:
based on identifying no errors in the updated first data, write the updated first data into the first memory.

19. The non-transitory computer-readable medium of claim 17, wherein the control device is a baseboard management controller (BMC), the second memory is a memory of the BMC, and the first data is field replaceable unit (FRU) data.

20. The non-transitory computer-readable medium of claim 17, wherein the set of instructions cause the one or more processors to:
determine whether the update of the first data in the second memory is complete; and
based on detecting that the update of the first data in the second memory is complete, verify the updated first data in the second memory.
